(19) United States
(12) Patent Application Publication
(10) Pub. No.: US 2009/0066835 A1
(43) Pub. Date: Mar. 12, 2009

(54) IMAGING SYSTEM AND IMAGING METHOD THEREOF

(75) Inventor: CHIUNG-FANG CHEN, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/104,666

(22) Filed: Apr. 17, 2008

(30) Foreign Application Priority Data
Sep. 6, 2007 (CN) 200710201608.0

(51) Int. Cl. H04N 5/222; G03B 15/03

(52) U.S. Cl. 348/370; 348/333.02; 396/157

(57) ABSTRACT

An imaging system includes an attention-getting unit. The attention-getting unit is configured for attracting the attention of a human subject to the imaging system.

### BACKGROUND

1. Technical Field

The invention relates to imaging systems and, particularly, to an imaging system having an attention-getting function and an imaging method.

2. Description of Related Art

Kids and pets have their own individual personalities, and it is nice to capture those personalities. However, it is challenging to hold their attention and create a focal point in the pictures.

Therefore, it is desirable to provide an imaging system and an imaging method, which can overcome the above-mentioned problem.

### SUMMARY

In a present embodiment, an imaging system includes an attention-getting unit. The attention-getting unit is configured for attracting the attention of a live subject to the imaging system.

### BRIEF DESCRIPTION OF THE DRAWINGS

Many aspects of the present imaging system should be better understood with reference to the following drawings. The components in the drawings are not necessarily drawn to scale, the emphasis instead being placed upon clearly illustrating the principles of the present imaging system. Moreover, in the drawings, like reference numerals designate corresponding parts throughout the several views.

FIG. 1 is a front, schematic view of a digital still camera (DSC) including a display panel at an unfolded position, according to an exemplary embodiment.

FIG. 2 is a functional diagram of the DSC of FIG. 1.

### DETAILED DESCRIPTION OF THE EMBODIMENTS

Embodiments of the present imaging system will now be described in detail with reference to the drawings. In the following described embodiments, the imaging system is a digital still camera (DSC). But it should be understood that this imaging system should read broadly to encompass the following devices: film cameras, digital video cameras, and tape video cameras.

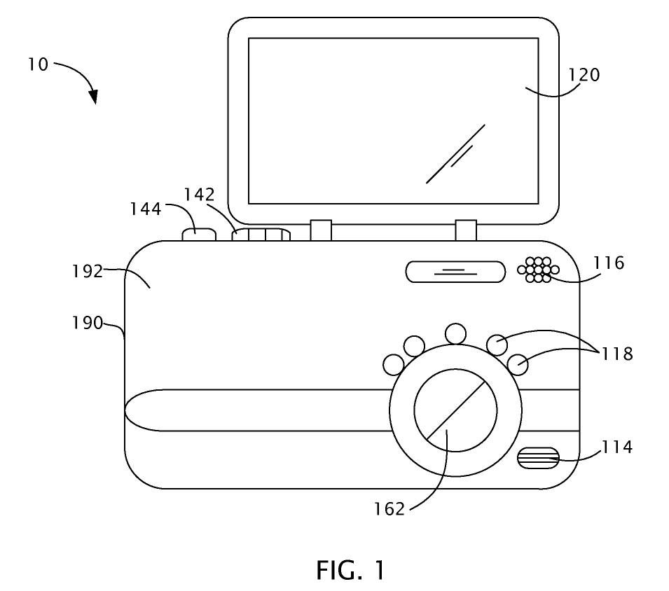

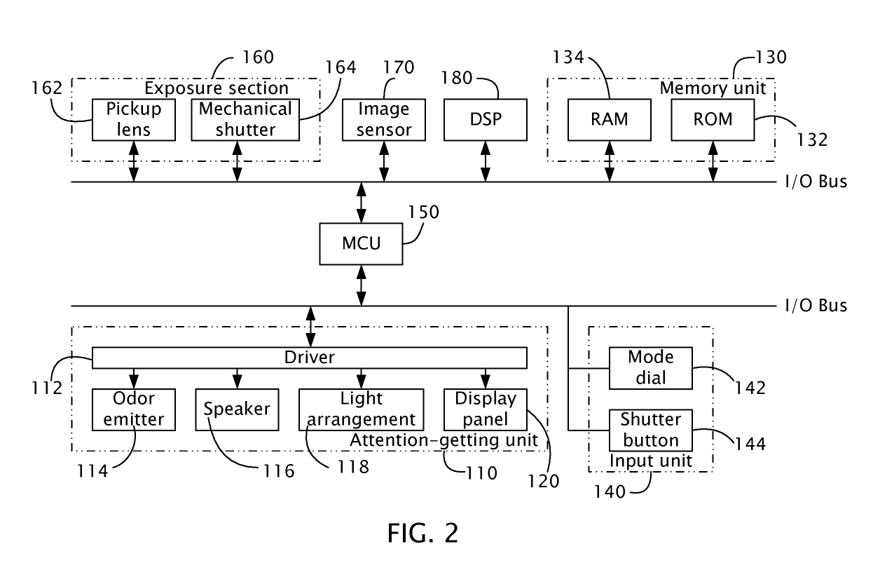

Referring to FIGS. 1, 2, a DSC 10, according to an exemplary embodiment, includes an attention-getting unit 110. The attention-getting unit 110 is configured for attracting the attention of a live subject such as a young child to the DSC 10 by means of, for example, odors, sounds, and/or some visible cue.

The attention-getting unit 110 can include a driver 112, an odor emitter 114, a speaker 116, a light arrangement 118, and a display panel 120. The driver 112 is configured for driving the odor emitter 114 to emit attention-getting odor (e.g., pleasant or unusual scent), the speaker 116 to make attention-getting sound (e.g., rhymes, animal sounds etc.), the light arrangement 148 (e.g. colored light emitting diode/s) to light in an attention-getting manner, and the display panel 120 (e.g., liquid crystal display panel) to display attention-getting image/s (e.g., motion images of family member/s), thereby attracting the attention of the live subject. Understandably, the attention-getting unit 10 is not limited by this embodiment, and may only include the driver 112 and a part of the group of the odor emitter 114, the speaker 116, the light arrangement 118, and the display panel 120. Also, it can employ more attention-getting elements such as attachable ornaments.

In addition to the attention-getting unit 110, the DSC 10 typically further includes a memory unit 130, an input unit 140, and a micro control unit (MCU) 150. How the odor emitter 114, the speaker 116, the light arrangement 118, and the display panel 120 cooperate, e.g., activate simultaneously, or in a predetermined sequence, can be programmed as software instructions. These software instructions are stored in the memory unit 130, and can be triggered by the user via the input unit 140. After being triggered, these software instructions are executed by the MCU 150 to generate control signals. The driver 112 reads the control signals and thereby controls the attention-getting unit 110 to operate in a desired manner. In detail, the memory unit 130 includes a read only memory (ROM) 132, and a random-access memory (RAM) 134. The input unit 140 includes a mode dial 142, and a shutter button 144. The software instructions are stored in the ROM 132, and one or more corresponding selectable modes (including, e.g., pet attention-getting mode, and child attention-getting mode) are represented on the mode dial 142. When a specific mode (e.g., pet attention-getting mode) is selected by the user via the mode dial 142, corresponding software instructions are loaded into the RAM 134 and executed by the MCU 150. If an auxiliary light is involved in the image taking process, the attention-getting unit 110 should be inactivated before the shutter button 144 is fully depressed (shutter button typically can be depressed half-way to lock exposure and focus, and fully depressed to capture an image) to avoid the auxiliary light affecting the captured image.

Specifically, the DSC 10 typically further includes a housing 190 that includes a front surface 192. The odor emitter 114, the speaker 116, and the light arrangement 118 are mounted on the front surface 192 so as to efficiently aim odors, sounds, and light therefrom to the subject. The display panel 120 is pivoted to the housing 190 such that the display panel 120 can be folded (the display panel 120 lies on the rear surface of the housing 190) to show information for the user, or unfolded (the display panel 120 stands on the housing 190) to present the attention getting image/s to the subject. The mode dial 142 and the shutter button 144 are also mounted on the housing 190 (typically on the top surface).

The DSC 10 also includes an exposure section 160, an image sensor 170, and a digital signal processor (DSP) 180. The exposure section 160 includes a pick up lens 162, and a mechanical shutter 164. The pick up lens 162 is mounted on the front surface 192, and is configured for directing light from the subject onto the image sensor 170. The mechanical shutter 164 is typically embedded in the pick up lens 162, and is configured for exposing the image sensor 170 to the directed light of the pick up lens 162. The image sensor 170, such as a charge coupled device (CCD) image sensor, is configured for continuously exposing itself to the directed light from the pick up lens 162 in the exposure time of the mechanical shutter 164, thereby capturing a number of consecutive image signals. The DSP 180 is configured for processing the image signals to extract control data such as auto focus (AF) data, auto exposure (AE) data, and auto white balance (AWB) data, when the shutter button 164 is depressed half-way, and encoding the last image signal of the consecutive image signal as a still image, after the shutter button 164 is fully depressed. The still image can be stored to the ROM 132 or shown on the display panel 120. The odor emitter 114, the speaker 116, and the light arrangement 118 may be arranged directly around the pick up lens 162 so as to attract the eyes of the subject to look directly into the pick-up lens 162.

Various components of the imaging system 10 such as the driver 112, the memory unit 130, the MCU 150, the image sensor 170, and the DSP 180 can be can be assembled to a circuitized board which is sealed within the housing 190, and thereby interconnect with each other. The attention-getting unit 110, the memory unit 130, the input unit 140, the exposure section 160, the image sensor 170, the DSP 180 can communicate with the MCU via an input/output (I/O) bus.

It will be understood that the above particular embodiments and methods are shown and described by way of illustration only. The principles and the features of the present invention may be employed in various and numerous embodiment thereof without departing from the scope of the invention as claimed. The above-described embodiments illustrate the scope of the invention but do not restrict the scope of the invention.

What is claimed is:

1. An imaging system comprising an attention-getting unit for attracting the attention of a human subject to the imaging system.

2. The imaging system as claimed in claim 1, wherein the attention-getting unit is integrated in the imaging system.

3. The imaging system as claimed in claim 1, wherein the attention-getting unit attracts the attention of the human subject via an information channel selected from a group of: odor, sound, and vision.

4. The imaging system as claimed in claim 1, wherein the attention-getting unit includes a light, the light being configured for emitting attention-getting light rays to the human subject.

5. The imaging system as claimed in claim 4, wherein the light includes a light emitting diode.

6. The imaging system as claimed in claim 4, further comprising a housing and a pick up lens, the housing including a front surface, the pick up lens being mounted on the front surface, the light being mounted on the front surface and arranged around the pick up lens so as to attract the attention of the human subject to the pick up lens.

7. The imaging system as claimed in claimed claim 4, wherein the attention-getting unit further includes a driver, the driver being configured for driving the light to emit the attention-getting light rays.

8. The imaging system as claimed in claim 1, wherein the attention-getting unit includes a speaker, the speaker being configured for playing an attention-getting sound for the human subject.

9. The imaging system as claimed in claim 8, wherein the attention-getting unit further includes a driver, the driver being configured for driving the speaker to make sound.

10. The imaging system as claimed in claim 1, further comprising a housing that includes a front surface, the speaker being mounted on the front surface so as to efficiently transmit the sound to the human subject.

11. The imaging system as claimed in claim 1, wherein the attention-getting unit includes a display panel, the display panel being configured for displaying an attention-getting image to the human subject.

12. The imaging system as claimed in claim 11, further comprising a housing that includes a front surface, the display panel being pivoted on the housing such that the display panel is capable of positioning at a first position to show information to a user, and positioning at a second position to present the attention-getting image to the human subject

13. The imaging system as claimed in claim 1, wherein the attention-getting unit includes an odor emitter, the odor emitter being configured for emitting an attention-getting odor to the human subject.

14. The imaging system as claimed in claim 1, further comprising a memory unit, an input unit, and a micro control unit, the memory unit being configured for storing software instructions, the input unit being configured for receiving an user input to trigger execution of the software instructions in the micro control unit to control the attention-getting unit to operate in a corresponding manner.

15. The imaging system as claimed in claim 14, wherein the input unit includes a mode dial, the mode dial being configured for triggering different operative manners of the attention-getting unit, each of which is represented as a mode on the mode dial.

16. The imaging system as claimed in claim 1, further including an exposure section, an image sensor, a digital signal processor, and a micro control unit, the exposure section being configured for directing light from the human subject onto the image sensor and exposing the image sensor to the directed light, the image sensor being configured for continuously exposing itself to the directed light from the exposure section in the exposure time of the exposure section to form a plurality of consecutive image signals, the digital signal processor being configured for processing the image signals to extract a control data, and encoding the last image signal of the image signals as a still image, the micro control unit being configured for receiving the control signal and thereby controlling the imaging system to perform a corresponding function.

17. The imaging system as claimed in claim 1, being selected from a group of: digital still camera, film camera, digital video camera, and tape video camera.

18. An imaging method for an imaging system, the method comprising:
selecting an attention-getting mode, the attention-getting mode being built in the imaging system, and configured for control the imaging system to perform an attention-getting function for attracting a human subject;
focusing the imaging system on the human subject; and
stopping performing the attention-getting function.

19. The imaging method as claimed in claim 18, further comprising:
taking an image after the step of stopping.

20. The imaging method as claimed in claim 18, wherein the attention-getting function is performed by an attention-getting unit, the attention-getting unit being included in the imaging system.
